(19) United States
(12) Patent Application Publication
(10) Pub. No.: US 2003/0164807 A1
(43) Pub. Date: Sep. 4, 2003

(54) Screen

(76) Inventor: Rainer Glatzer, Geoyensgucinch (DE)

Correspondence Address: WILLIAM COLLARD, COLLARD & ROE, P.C., 1077 NORTHERN BOULEVARD, ROSLYN, NY, 11576, US

(21) Appl. No.: 10/363,959

(22) PCT Filed: Sep. 7, 2001
(86) PCT No.: PCT/EP01/10367

(30) Foreign Application Priority Data
Sep. 9, 2000 (DE) 100446647

(51) Int. Cl. G09G 3/00

(52) U.S. Cl. 345/31

(57) ABSTRACT

The invention relates to a screen comprising a visible surface (1) which is divided up into pixels (2). The pixels (2) thereof respectively emit light and are connected to a light distributor by means of optical waveguides (3). The light distributor has rotating light sources (10) disposed on a rotor (20) and arranged at a distance from an axis of rotation (22). The light emitted from said light sources is radiated to the receptors (7) of a coupling device (5) located at the ends of the wave guides (3) and reaches the visible surface (1) of the screen via the individual waveguides (3), thereby producing a visible picture for an observer, composed of individual pixels (2). The disadvantage of conventional screens is that the design thereof is necessarily large while displaying weaknesses in terms of contrast and light. The aim of the invention is to cause the rotating light sources arranged in the light distributor to emit light parallel to the axis of rotation (22) and radiate it to the receptors (7) of the coupling device (5), one particular advantage thereof being a flat design.

The invention relates to a display screen that comprises a visible surface that is divided in pixels. The picture pixels of this surface each emit light and are connected with a light distributor by means of optical light wave guides. The light distributor is arranged on a rotor that comprises rotating light sources. The light sources are arranged at a distance from the axis of rotation and the light emitted by the light sources is transmitted to receptors that are arranged on the ends of a coupling device that is arranged on the ends of the optical light wave guides. Via the individual optical light wave guides, the light is received on the visible surface of the display screen and generates there a visible picture that is composed of the individual pixels and visible to the viewer.

Conventional display screens are based on the principle of the Braun's tube, as a rule. Both the home television viewer and also most data processing installations employ this technology for visualizing information. A reproduction screen is in this connection bombarded with accelerated electrons that generate a visible emission of light when they impact the screen that is dependent upon their kinetic energy. The trajectory of the electron and the position of the impact are controlled by means of an external magnetic field. A serious drawback of such a device lies in the fact that the device necessarily has to have a large-sized construction so as to able to receive pictures that are free of distortion; in particular, it has to have a great depth of the construction. Furthermore, such an arrangement is suited only for display screens of up to a defined maximum size.

Liquid crystal displays are increasingly used as of more recent times for flatter display screens. Such display screens are been successfully used and have gained acceptance in particular in the area of portable computers. However, owing to the fact that such display screens are based on a manufacture that requires substantial expenditure, the cost of the final product is extremely high. Furthermore, each variation of the liquid crystal displays that have become known to date requires a polarization of the light perceived by the user. Since such polarization is connection with light intensity losses in excess 50%, the light of these display screens is extremely weak, and their contrast is extremely poor as well. Viewing such a display screen can put much on strain on the human eye.

In addition to the widely known methods, the European patent application EP 99 927 828.6 of the applicant in the present case describes a display screen that is also illuminated by means of light-conducting fibers in a manner satisfying the requirements. Said invention, however, requires a light modulator between the light source and the visible surface of the display screen that is preferably comprised of so-called shutters. The manufacture of such a light modulator requires a highly advanced special technology, and it is consequently extremely costly.

Furthermore, a display screen of the type involved in the present case is known from U.S. Pat. No. 3,744,048, in connection with which the light is distributed to the individual optical light wave guides by means of a cylindrical rotor. The display screen is illuminated in that connection by gaps, whereby complete gaps are sequentially supplied with light in the direction of the lines. However, the technology proposed there is afflicted with a number of drawbacks. On the one hand, the light rays have to be deflected in the optical light wave guides from the rearward side of the rotating cylinder by 180°, to the visible surface of the display screen, which highly raises the loss in the optical light wave guides. Moreover, the proposed system requires an extremely high amount of space and therefore almost makes it impossible to realize a modular structure, for example of the type of display screen modules that neighbo on one other. An additional drawback ensues from the vibrations that are caused at high rotational speeds by the unbalance of the cylindrical rotor, which, in addition to high emission of noise, results in high wear as well.

Starting out on the basis of the drawbacks afflicting the prior art described above, the invention is based on the problem of further developing the display screen of the type specified above in such a manner that a flat type of construction of such a display screen can be realized also in conjunction with a large visible surface, preferably in the modular manner; and that a high measure of brightness as well of contrast will be available to the user.

For solving this problem, the invention proposes on the basis of the display screen of the type described above that rotating light sources arranged in the light distributor emit light in parallel with the axis of rotation and radiate light to the receptors of the coupling device.

The special benefit of the display screen as defined by the invention lies in the flat type of construction as defined by the invention. As opposed to the display screen already known, the light is guided from the light sources to the visible surface of the display screen by means of the optical light wave guides with minimal deflection and via the shortest path. In addition to the benefit of minimal space requirements, intensity losses are avoided in this manner as well.

The rotation of the light sources, which are rotating with a spacing from the axis of rotation of the rotor, permit a successive illumination of pixels or groups of pixels in terms of time. An accordingly high rotational speed of the rotating light sources conditions a perception of a mean brightness of the individual pixels by the human eye. The frequency of the build-up of the pictures can be advantageously increased with minor expenditure depending on the number of light sources, the number of pixels, and the rotational speed of the rotor, so that the visible surface is always free of flicker to the human eye. The embodiment as defined by the invention benefits in this connection from the minimal space requirements because the unbalances and resulting vibrations can be reduced to a minimum. As opposed to the available solutions of the prior art, the novel display screen technology is not based on any weakening of the light intensity conditioned by the principle. The light intensity and the non-flickering pictures permit viewing the screen in a large format and in a relaxing manner. While conventional picture tubes do not permit any reproduction of flicker-free pictures on a large-sized visible surface of, for example several square meters, no limitation of the format conditioned by the principle exists in connection with the technique as defined by the invention. The problems that arise in connection with display screens based on liquid crystal, which pertain to the required accuracy of layer covers, are eliminated as well.

According to the invention, it is possible to realize a modular structure in an extremely simple manner. It is conceivable in this connection to build up the visible surface of a display screen from a number of individual modules that are arranged one on top of each other and next to one another, with each module having its own rotor.

In order to assure a uniform structure and a uniform brightness of the visible surface of the display screen, it is useful if the receptors of the optical light wave guides are arranged in the coupling device in the peripheral direction of the rotational motion of the rotor in an equidistant manner.

For obtaining a particularly high yield of light, it is useful if the light sources, in particular light-emitting diodes, are operated with a pulsed voltage. The light of a light-emitting diode that is operated with a pulsed voltage is maximally ten times brighter than when it is operated with a constant voltage.

In the interest of a particularly good illumination of the visible surface of the display screen, it is useful, furthermore, if the voltage with which the light source is operated is pulsed in such a manner that the light source radiates light only if it is positioned directly opposite the receptor of an optical wave guide leading to the visible surface of the display screen. By operating the light source, preferably a light-emitting diode with a pulsed voltage, the maximal brightness of this light source is increased, on the one hand. On the other hand, switching off the light source at times during which the transmission to the visible surface of the display screen is interrupted, leads to lower energy requirements.

According to a beneficial further development of the invention, provision is made that the voltage for operating the light source is controlled in such a manner that the light is radiated from the light sources to the receptors of the optical light wave guides at a defined angle deviating from the light that is incident in a vertical manner. The light incidence can be influenced via a corresponding time offset in the pulsation of the operating voltage in such a manner that a constant offset of the angle of rotation is always obtained between the receptor and the light source. The angle of incidence in the optical light wave guide to the visible surface effects, on the precondition that the cross section of the light wave guide is constant over the length, an identical outlet angle of the light exiting from the optical light wave guide on the visible surface. It is possible in this manner to generate a well-illuminated picture for defined viewing angles that is particularly rich in contrast, or to obtain a stereoscopic effect. The generation of vexation pictures or even three-dimensional representations is possible in this manner as well.

According to an advantageous further development of the invention, provision is made that the rotor is equipped with three different types of light-emitting diodes. The light-emitting diodes preferably emit red, green or blue light. The light sources mounted on the rotor successively transmit light to the receptors of the light wave guides, which are combined to form a coupling device.

In addition to the variation with an angle of incidence of the light in the peripheral direction of the rotor, a controlled change in the angle of incidence of the light in the radial direction is conceivable as well. For this purpose, provision is made according to the invention that individual light sources can be shifted by means of an actuator. Other effects can be achieved by displacing the rotor or the coupling device with the help of actuators. Owing to the fact that only small distances have to be covered by the actuators due to the small dimensions, piezo elements are excellently suited. In addition to an operating mode that is almost free of wear, piezo elements allow a very rapid displacement of the components to be moved.

The rotor preferably has the shape of a disk or of a star. This assures minimal dimensions, unbalances and moments of inertia. In particular if the rotor is realized in the form of a star, it is useful the mount the light sources on the rotor in a hinged manner, so that the light sources are automatically centered in their operating positions when the rotational speed increases due to centrifugal forces. A wobbling type of unbalance is excluded in this manner. The individual joints can be advantageously realized in the form of springs or folding hinges. If necessary, the jointed, star-shaped carriers of the light sources may have a sliding support mounted on their outer ends, which is usefully made of Teflon. A magnetic support of the sliding support is conceivable as well.

For the purpose of visualizing still and also moving pictures, it is useful if the light sources are supplied with voltage via a control that converts video signals into the corresponding voltage pulses for the light sources depending on the angle of rotation of the rotor. In connection with a light source with a pulsation that is adapted to the frequency at which the receptors are swept, such a signal is advantageously still modulated according to the picture to be represented in a manner such that the red, green and blue components of the light emitted by the pixels will correspond with the picture to be represented on the visible surface. So that the phase angle of the rotation of the rotor will always be aligned with the control of the light sources, it is useful if the light distributor transmits a signal to the control once per each rotation of the rotor. Presetting of the pulsation or of the cycle frequency of the control of the light source by the number of revolutions of the rotor in such a manner that a cycled pulse is transmitted to the control each time a light radiator is swept by a receptor, will assure constant synchronization between the rotor and the control in a reliable manner.

Instead of a galvanic connection of the light sources via sliding contacts with a voltage source or the control, it is useful if the rotating light sources are supplied with the operating energy inductively by means of an external magnetic field.

Provision is made according to the invention that the rotor is driven by means of an electric motor. It is just as useful in this connection to realize the rotor itself in the form of an armature of a dc or ac motor in particular if stationary light sources are used. In the interest of a flat type of construction without any sliding contact and a long shelf life, the drive of the rotor should be realized in the form of an electric motor of the external-rotor type of construction. In this connection, the rotor itself may form the external rotor.

For the purpose of minimizing the amount of interfaces between rotating and stationary components, it is useful if the control of the light sources is forming an integral component of the rotor. In this connection, complex video signals advantageously do not have to be transmitted via sliding contacts for controlling the rotor, but have to be transmitted optically to the control that is integrated in the rotor.

The optical wave guides employed may be made of both polymer and glass fibers. The use of polymer offers in this connection the benefit that polymer fibers are much less expensive and have almost identical functions, in particular in regard to their transmission property. Instead of using the core-cladding fibers that are usually employed, it is more useful if plexiglass fibers are employed because the degree of efficiency of the total reflection of plexiglass fibers amounts to almost 100%.

An arrangement of the optical light wave guides that is friendly in terms of its manufacture and space-saving, is obtained if the receptors of the coupling device for individual segments of the display screen are arranged in a straight line and the corresponding straight lines are each arranged around the axis of rotation of the rotor in the form of a star. The visible surface can be advantageously subdivided in this manner in lines or line sections that lead to a group of receptors that is arranged on a straight line. Such groupings of optical light wave guides can each be realized in a standardized, identical manner. It is useful in this connection if the coupling device is realized with identical circular or ring segments, in which the receptors for individual segments of the display screen are arranged. A corresponding modularization would be possible in the sense that optical light wave guides arranged one after the other on the side facing the visible surface of the display screen, are combined in a line or gap segment that has a rectangular cross section, and are arranged one after the other at the other end in a circular or ring segment that has a shape like a piece of cake in terms of space. A multiple modular structure can be realized in this manner as well. For example, lines or line sections can be combined in the manner described above to form basic modules, and combined, for example in quarter circles on the side of the coupling device, or to form a quarter segment of the visible surface of the display screen. It would be possible in this connection to realize both each basic module and also each quartered component of the arrangement of the coupling device in an identical manner.

According to another advantageous further development of the invention, provision is made that the components of the coupling device belonging to individual segments of the display screen are provided with a digital or analog coding, and that an optical reading device is arranged on the rotor, by means of which the respective component of the coupling arrangement is identified. The synchronization between the position of the rotor and the control of the display screen is always assured in this manner.

For reducing the reflection of foreign light radiating into the display screen from the outside, it is useful if the visible surface of the display screen is darkened or dyed in black in a manner ensuing poor reflection, except for the outlet openings of the optical light wave guides. In addition, it is useful if the optical wave guides on the side of the coupling arrangement feed into an environment that has poor reflection or that is dyed in black, with exclusively the light sources emitting light in said environment. If the rotor is realized in the form of a disk, black dying is useful on the side of the rotor facing the face of the optical wave guides.

In the interest of a high degree of efficiency of the optical wave guides, it is useful if the limiting walls of the optical wave guides extending in the longitudinal direction are mirrored in the area where they are combined to form the coupling arrangement, or toward the visible surface. In this way, the contact of the optical wave guides with the neighboring components is almost harmless to the degree of efficiency of the transmission, or to the reflection on the lateral limitation walls of the optical wave guides. For a rigid and vibration-resistant connection between the rotor, the drive, the bundles of optical wave guides and the visible surface, it is useful if the rotor is driven by a drive that is located between the rotor and the visible surface of the display screen, and arranged centrally between the optical wave guides. The multitude of the optical wave guides are forming a stable composite that is excellently suited for securing the drive.

For a precise arrangement of the individual optical wave guides on the coupling device, it is useful if a great number of optical wave guides are combined in flat-band composites. Such flat-band composites can be beneficially combined in a circular or ring-shaped, molded piece, for example by casting them in synthetic resin. The flat-band composite in particular assures in this connection that the individual optical wave guides are safely spaced from each other.

In order to avoid soiling, transmission of body sound and flow noise, the drive or the rotor or a complete display screen module or the entire display screen, or all of its components can be realized in a gas-tight manner. In the field of medical technology, a gas-tight embodiment of the device facilitates hygienic treatments.

The invention is explained in greater detail in the following with the help of a special exemplified embodiment and by reference to the drawing, in which:

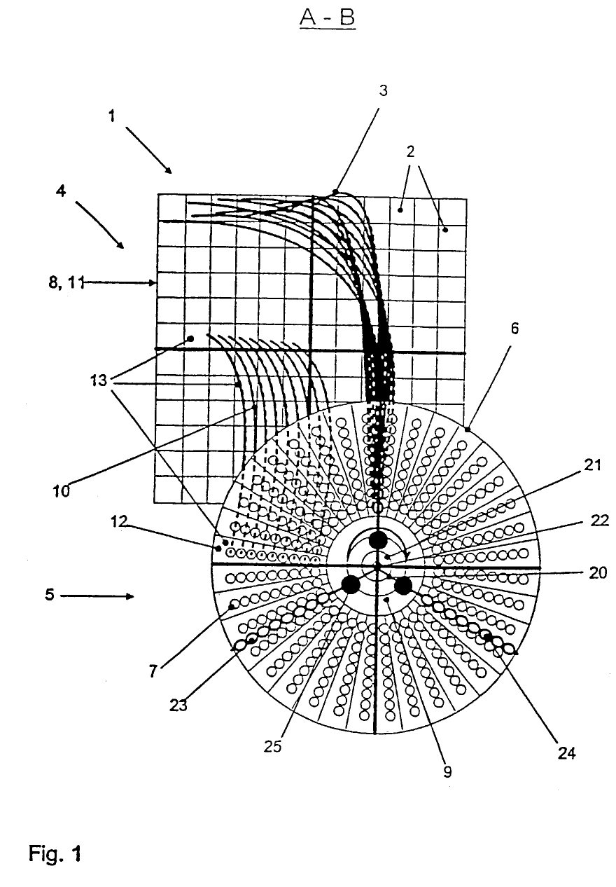

FIG. 1 is a basic sketch of the structure and the mode of operation of a display screen as defined by the invention that is represented against the direction in which it is seen by a viewer; and

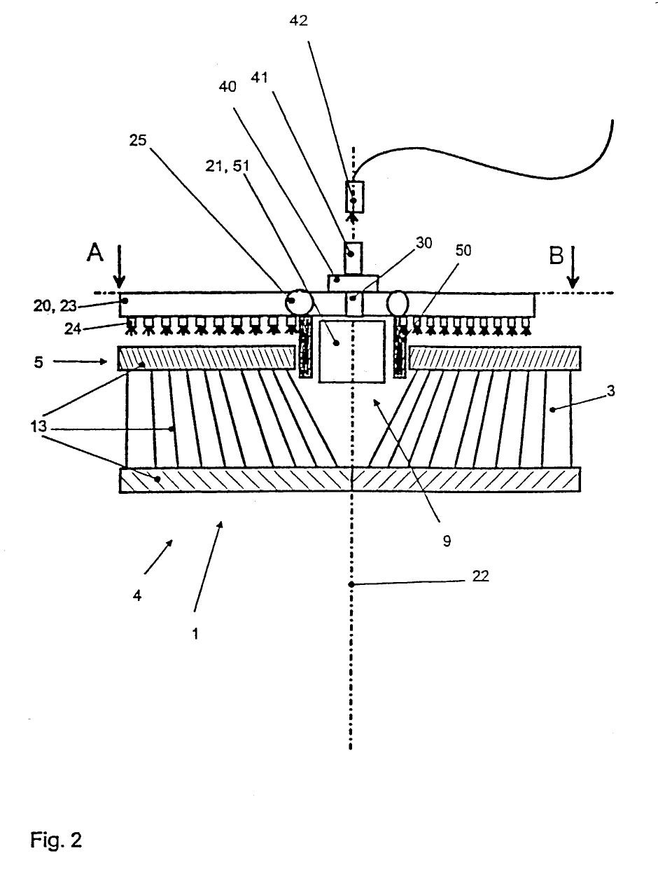

FIG. 2 is a partly cut, schematic representation of a display screen as defined by the invention transversely to the visible surface.

In the exemplified embodiment shown, the visible surface 1 of the display screen is denoted by the reference numeral 1. The visible surface 1 is divided in a multitude of the pixels 2 in the manner of a matrix, in which each pixel is connected with an optical wave guide 3. On the side of the visible surface 1 of the display screen that faces the viewer, said side not being shown, the visible surface 1 is dyed in black with poor reflection, with the exception of the outlet openings of the optical wave guides 3. The entire visible surface 1 is subdivided in the four identical picture segments 4.

Seen from the position of the viewer, a coupling device 5 is arranged behind the visible surface 1 of the display screen. In accordance with the division of the visible surface 1 in the four picture segments 4, the coupling device 5 is divided in the four modules 6 as well. In the individual modules 6, the optical wave guides 3 starting from the picture segments 4 of the visible surface 1, are combined at their ends, the latter forming the receptors 7 for incident light.

One line 8 of each of the pixels 2 of a picture segment 4 is extending to the coupling device 5 by means of the optical wave guides 3 starting from the pixels 2, whereby the optical wave guides 3 of each line 8 are combined in a flat-band composite and arranged on the coupling device in a straight line, which, in extension, is extending through the center point of the coupling device 5.

The coupling device 5 is realized in a round shape, whereby it is provided with a central recess 9. The individual flat-band composites 10 of the optical wave guides 3 are combined on the side of the visible surface 1 in the elements 11 that are segmented into the pixels 2 and have a rectangular cross section. The individual elements 11 consist of cast synthetic resin material and are assembled with each other by means of groove-and-spring connections.

On the side of the coupling device 5, the optical wave guides 3 belonging to a flat-band composite 10 each are provided with a surrounding, cast attachment 12 that has the shape of a circular ring segment or of a piece of cake. The basic elements 13 comprised of the elements 11 with the rectangular cross section, the flat-band composites 10 of the optical wave guides 3, and the cast attachments 12 with the shape of a piece of cake are standardized for the entire visible surface 1 of the display screen, and are realized in an identical manner. Within the framework of the manufacturing process, the basic elements 13 are first assembled on the side of the coupling device 5 to form the quarter circle-shaped modules 6. Subsequently, the picture segments 4 are joined and the modules 6 are assembled to form the visible surface 1 or the coupling device 5. In the area where the optical wave guides 3 are combined on the side of the visible surface 1 and the coupling device 5, the limiting surfaces extending in the longitudinal direction of the optical wave guides 3 are mirrored, so that the degree of efficiency of the transmission of the optical wave guides 3 is not deteriorated by the contact with the synthetic resin cast.

Each of the modules 6 is provided with a binary coding (not shown) on the side of the coupling device 5. For this purpose, the ends of the flat-band composites 10 on the side of the coupling device 5 of the optical wave guides 3 are each dyed in a different sequence, so that it is possible by means of a scanning laser (not shown) to read an individual binary code through the synthetic resin of the cast attachment 12, the latter being permeable to such transmission.

The rotor 20 is arranged behind the coupling device 5, viewed from the side of the viewer. The rotor is put into rotation by a drive 21 and is rotating in the manner shown around a central axis of rotation 22 in the center of the coupling device 5. The three arms 23 are attached to the rotor 20 in the form of a star, starting from the axis of rotation 22. In the area of the receptors 7 of the coupling device 5, these arms are provided with the light-emitting diodes 24. The light-emitting diodes 24 emit light into the receptors 7 as required. Between the axis of rotation 22 and the light-emitting diodes 24, the arms 23 are each provided with a joint 25 that permits a movement of the arms 23 in the direction of the axis of rotation 22. In this way, each of the arms 23 is automatically centered by the centrifugal forces of the rotation in a manner free of wobbling.

The drive 21 of the rotor 20 is centrally arranged in the coupling device 5 and between the optical wave guides 3. A driving shaft 30 of the drive 21 is extending through the central recess 9 of the coupling device 5 to the rotor 20. A control 40 for the light-emitting diodes 24 is rotating together with the rotor 20. A receiver 41 for video signals is arranged on the control 40. The video signals are transmitted by an infrared transmitter 42 to the receiver 41 and are evaluated by the control 40, which correspondingly supplies the light-emitting diodes 24 with the voltage pulses. The control 40 and the drive 21 are inductively supplied with energy. The drive 21 is realized in the form of an external rotor with an internal coil arrangement 51 and an external ferritic rotor 50.

1. A display screen with a visible surface (1) divided in pixels (2), with the pixels of said visible surface each emitting light and being connected with a light distributor that comprises rotating light sources (10) arranged on a rotor (20), the light sources being arranged with a spacing from the axis of rotation (22) and their emitted light being radiated into receptors (7) of a coupling device (5), said receptors being arranged on the ends of the optical wave guides (3), said light being received via the individual optical wave guides (3) on the visible surface (1) of the display screen, and a picture is produced there that is visible to the viewer and assembled from the individual pixels (2), characterized in that the rotating light sources (10) arranged in the light distributor emit light parallel with the axis of rotation (22) and into the receptors (7) of the coupling device (5).

2. The display screen according to claim 1, characterized in that the light sources (10) are operated with a pulsed voltage.

3. The display screen according to claim 2, characterized in that the voltage is pulsed in such a manner that the light sources (10) emit light only when they radiate nearly centrally directly into a receptor (7) of the coupling device (5) of an optical wave guide (3), such receptor leading to the display screen.

4. The display screen according to claim 1, characterized in that the operating voltage for the light sources (10) is controlled in such a manner that the light from the light sources (10) radiates into the receptors (7) of the optical wave guides (3) at a defined angle deviating from the vertical light incidence.

5. The display screen according to claim 1, characterized in that the individual light sources (10) or the rotor (20) or the coupling device (5) can be displaced by means of an actuator.

6. The display screen according to claim 1, characterized in that the rotor (20) is realized in the form of a disk or star.

7. The display screen according to claim 1, characterized in that the light sources (10) are supplied with voltage via a control (40), said control converting signals (14) into the corresponding voltage pulses for the light sources (10) depending on the angle of rotation of the rotor (20); and that the light distributor transmits a signal to the control (40) at least once per each rotation of the rotor (20).

8. The display screen according to claim 1, characterized in that a voltage generator is integrated in the rotor (20), said voltage generator inductively supplying the rotating light sources (10) because of an external magnetic field.

9. The display screen according to claim 1, characterized in that the control (40) of the light sources (10) is an integral component of the rotor (20).

10. The display screen according to claim 9, characterized in that the signals (14) are optically transmitted to the control (40) integrated in the rotor (20).

11. The display screen according to claim 1, characterized in that the light sources (10) are mounted articulated on the rotor (20) and move into the operating position when the rotational speed rises due to centrifugal forces.

12. The display screen according to claim 1, characterized in that the receptors (7) of the coupling device (5) for individual display screen segments are arranged in a straight line, and the straight lines are arranged around the axis of rotation (22) of the rotor (20) in the form of a star.

13. The display screen according to claim 1, characterized in that the coupling device (5) is comprised of identical circular or ring segments, in which the receptors (7) for the individual display screen segments are arranged.

14. The display screen according to claim 1, characterized by the fact that the components of the coupling device (5) belonging to individual display screen segments are provided with a digital or analog coding; and that an optical reading device is arranged on the rotor (20), by means of which the respective component of the coupling device (5) is identified.

15. The display screen according to claim 1, characterized in that each pixel (2) of the visible surface (1) has an outlet opening for an optical wave guide (3); and that the surface around the outlet opening is darkened or dyed in black with poor reflection.

16. The display screen according to claim 1, characterized in that the limiting walls of the optical wave guides (3) extending in the longitudinal direction are mirrored in the coupling and/or de-coupling sites, in each case in the area where such optical wave guides are combined to form the coupling device (5).

17. The display screen according to claim 1, characterized in that the rotor (20) is driven by a drive (21) located between the rotor (20) and the visible surface (1) of the display screen, and arranged between the optical wave guides (3).

18. The display screen according to claim 1, characterized in that a multitude of optical wave guides (3) are combined in each case to form flat-band composites.

19. The display screen according to claim 1, characterized in that the drive and/or the rotor and/or the display screen module and/or the entire display screen are realized in a gas-tight manner.
